(19) United States
(12) Patent Application Publication
(10) Pub. No.: US 2006/0260227 A1
(43) Pub. Date: Nov. 23, 2006

(54) Energy efficient window

(76) Inventor: Alan H. Winfield, Edmonton (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/534,511

(22) PCT Filed: Nov. 13, 2002
(86) PCT No.: PCT/CA02/01753

§ 371 Date: Mar. 15, 2006

(51) Int. Cl. E06B 7/00

(52) U.S. Cl. 52/204.593

(57) ABSTRACT

A heat insulating window includes a pair of outer glass panes (10, 12) held apart by a spacing member (16) and surrounded by a frame. One frame member (26) serves as a dessicant concealing member which holds a removeable dessicant cartridge (44). The dessicant cartridge connects to a conduit system (42) providing gas communication to the air space between the glass panes (10, 12).

### FIELD OF THE INVENTION

The present invention relates to an energy efficient window and, in particular, to a desiccation system for energy efficient windows.

### BACKGROUND OF THE INVENTION

Windows or glass areas are a significant weakness in heat insulation schemes for buildings in hot or cold climates. A basic insulating window that is well-known is constructed from two panes of glass within a rigid frame. The air space between the panes provides heat insulation. It is also known to evacuate the air space or to fill the air space with a gas of lower thermal conductivity than air such as argon. One further method of enhancing the insulating value of such a window is to provide transparent partitions between the outer glass panes to reduce convective heat transfer within the unit. This may increase the air volume within the unit which may cause pressure-related difficulties to develop if the air volume is not vented. If the air volume is vented, a means of desiccating the air entering the unit must be provided.

Other technologies include providing selectively reflecting or low-emissivity coatings to reduce radiant heat transfer through the window. As well, there have been significant improvements in the window frame, both in the union of the glass panes and the design and material of the frame. The layers of glazing in an insulating unit must be held apart at the appropriate distance by spacers. Because of its excellent structural properties, window manufacturers have used aluminum spacers. Unfortunately, aluminum is an excellent conductor of heat and the aluminum spacer used in most standard edge systems represented a significant thermal “short circuit” at the edge of the insulating glass unit, which reduces the benefits of improved glazings. In addition to the increased heat loss, the colder edge is more prone to condensation.

In U.S. Pat. No. 4,563,843 (assigned to Sulzer Bros. Limited), a heat insulating window is described which includes outer glass panes and transparent partitions within the air space to suppress convective air flows. The frame includes opposing metallic frame members which are structurally joined together and separated by non-metallic webs to avoid thermal bridging between the inner and outer frame members. A thermoplastic piece serves as a spacer between the glass planes and to retain the transparent partitions. Other connecting webs define a drying chamber between the frame members which is filled with a desiccant. The outside of the frame is sealed with hot melt butyl and thin metal foils which have low thermal conductance and provide effective vapour barriers. It is necessary to vent the air space because of the large volume of air within these windows. If not vented, internal window pressures would increase to unacceptable levels, sufficient to break the glass in extreme instances, as a result of temperatures changes created by solar radiation. Because water vapour within the air space may result in condensation which impairs the transparency of the window unit, the air being vented into the airspace must be desiccated.

The drying chamber formed in the Sulzer patent is defined by the web and frame members and sealed within the window unit. Therefore, the desiccant is permanently installed within the window unit and cannot be replaced without destructively dismantling the window.

Therefore, there is a need in the art for an energy efficient window unit which includes a spacer configuration and desiccant system mitigating the difficulties posed by the prior art.

### SUMMARY OF THE INVENTION

The present invention is directed at energy efficient windows having an advanced desiccant system. Therefore, in one aspect, the invention comprises a heat insulation window comprising:
(a) a pair of outer panes defining an air space therebetween;
(b) a spacing member disposed between the outer panes which maintain the panes in a spaced-apart relationship, the spacing member being hollow and defining openings permitting gas communication between the air space and the interior volume of the spacing member;
(c) a desiccant material contained within the spacing member; and
(d) a frame surrounding a perimeter of the window, wherein the frame comprises:
   (i) at least one desiccant concealing member which is hollow and detachable from the frame;
   (ii) a desiccant cartridge removably disposed within the desiccant concealing member and
   (iii) conduit means for providing gas communication between the air space and the desiccant cartridge.
      The conduit means provides gas communication between the interior volume of the spacing member and the desiccant cartridge and may preferably be a tube. The desiccant cartridge preferably comprises an elongated cylindrical tube which fits within the desiccant concealing member, which is preferably elongated and has a substantially U-shaped cross-sectional profile.

In one embodiment, the frame comprises an outer channel member, an inner channel member, a web member disposed between the outer and inner channel members, and the desiccant concealing member is detachably connected to the inner channel member.

### BRIEF DESCRIPTION OF THE DRAWINGS

The invention will now be described by way of an exemplary embodiment with reference to the accompanying simplified, diagrammatic, not-to-scale drawings. In the drawings:

FIG. 1 is a perspective view of one embodiment of the present invention.

FIG. 2 is a cross-section of one embodiment of a window unit of the present invention along line 2-2 in FIG. 3.

FIG. 3 is a cross-section of the embodiment of FIG. 2 along line 3-3 in FIG. 2.

### DETAILED DESCRIPTION OF THE INVENTION

The present invention provides for an energy efficient, heat insulating window design. When describing the present invention, all terms not defined herein have their common art-recognized meanings.

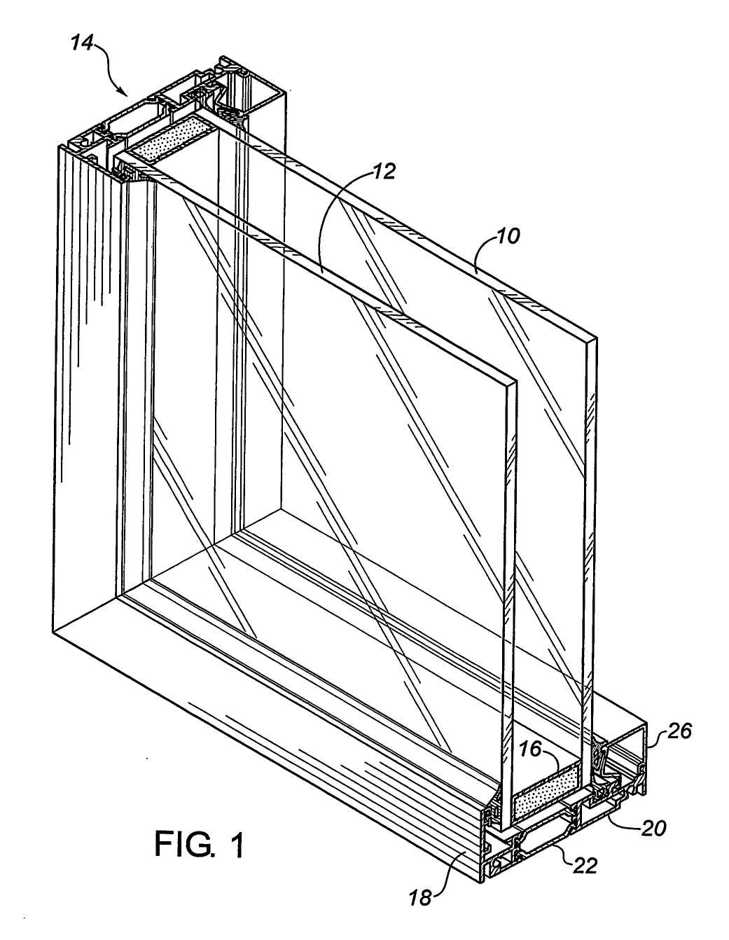

FIG. 1 shows an interior view of a window unit comprising dual glass panes (10, 12) and a frame (14).

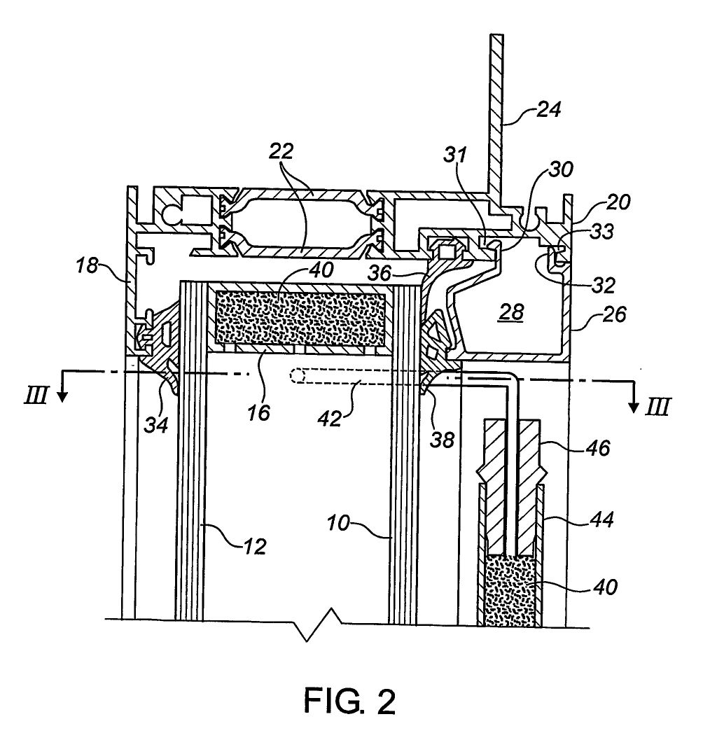

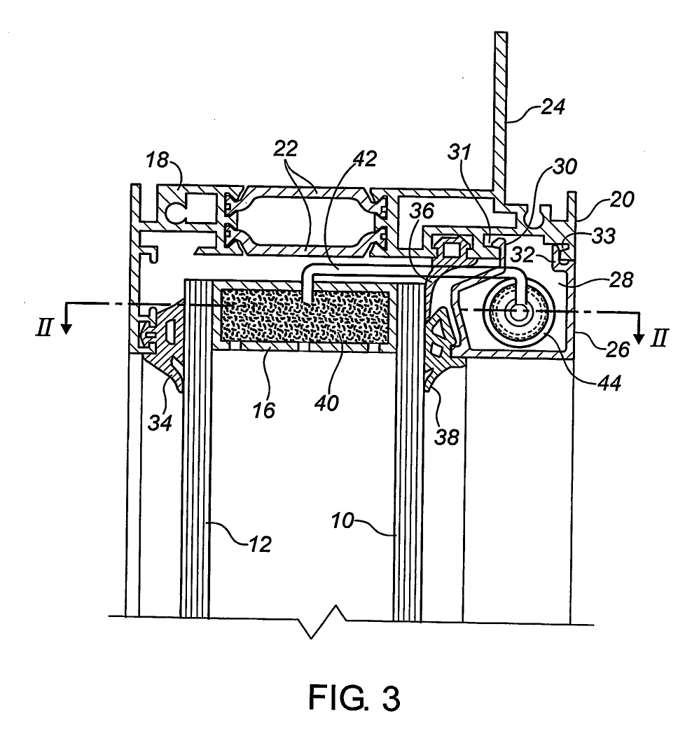

FIGS. 2 and 3 show cross-sections of the glass panes (10, 12) spaced apart by a spacer (16) and held together by the frame (14). The cross-sectional plane of FIG. 2 is normal to the cross-sectional plane of FIG. 3. Although for reference purposes, FIG. 2 will be described as a vertical cross-section and FIG. 3 is a horizontal cross-section, those orientations are not essential and may be reversed.

The frame comprises an outer channel member (18), an inner channel member (20) and dual intermediate web members (22) which join the inner and outer channel members. The inner channel member may include an installation flange (24) which projects outwardly and will abut a window jamb (not shown) when installed into a wall frame. A removable desiccant concealing member (26) is attached to the inner channel member (20) opposite the installation flange (24) which serves to retain the glass unit but does not serve any other structural function. The desiccant concealing member (26) is tube-shaped defining a single elongate channel (28). One edge of the channel defines a first lip (30) while the other edge of the channel defines a second lip (32). The two lips (30, 32) mate with corresponding grooves (31, 33) formed in the inner channel member (20).

The glass planes are positioned and retained by resilient seals (34, 38). Seal (34) is attached to the outer channel member (18) while seal (36) is attached to the inner channel member (20). Air seal (38) is attached to the desiccant concealing member (26). The seals are preferably formed from a material having low thermal conductivity and relatively impervious to moisture, such as neoprene, epdm or silicone rubber.

In a preferred embodiment, a dual desiccant system is employed. The spacer is a hollow rectangular member which is filled with a suitable desiccant (40). The spacer defines pores which allow air to circulate between the air space between the glass panes (10, 12) and the interior volume of the spacer which contains the desiccant. As well, a small conduit (42) connects the interior space of the spacer to a sealed tube (44) within the desiccant concealing member (26) which is filled with desiccant (40). The sealed tube (40) has a cap (46) which receives the conduit (42) thereby providing gas communication between the spacer interior volume and the desiccant tube (44).

As is apparent, the desiccant concealing member (26) may be removed from the frame (14) by disengaging the lips (30, 32) from the inner channel member (20), thereby exposing the desiccant tube (44). The desiccant tube (44) can then be easily disconnected from the conduit (44) and replaced with a fresh desiccant tube if necessary. In one alternative embodiment, the desiccant in the desiccant tube may be different from the desiccant contained in the spacer and has a higher affinity for water than the desiccant in the spacer. As will be appreciated by those skilled in the art, air which is drawn into the air space must pass through the replaceable desiccant tube, thereby preserving the dry atmosphere within the window unit.

Desiccant tubes (44) may be placed in one, two, three or all four desiccant concealing members (26) in any orientation.

The outer, intermediate and inner channel members which comprise the frame (14) may be formed from a thermoplastic material having low thermal conductivity such as polyvinylchloride or polyamide. Alternatively, the inner and outer channel members may be metallic members such as aluminum while the intermediate member is non-metallic, avoiding a thermal bridge between the two. The desiccant concealing members may be any suitable material such as a metal or a plastic, provided that it is resilient to facilitate its installation and removal from the inner channel member.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

What is claimed is:

1. A heat insulation window comprising:
(a) a pair of outer panes defining an air space therebetween;
(b) a spacing member disposed between the outer panes which maintain the panes in a spaced-apart relationship, the spacing member being hollow and defining openings permitting gas communication between the air space and the interior volume of the spacing member;
(c) a desiccant material contained within the spacing member; and
(d) a frame surrounding a perimeter of the window, wherein the frame comprises:
(i) at least one desiccant concealing member which is hollow and detachable from the frame;
(ii) a desiccant cartridge removably disposed within the desiccant concealing member and
(iii) conduit means for providing gas communication between the air space and the desiccant cartridge.

2. The window of claim 1 wherein the conduit means provides gas communication between the interior volume of the spacing member and the desiccant cartridge.

3. The window of claim 1 wherein the desiccant cartridge comprises an elongated cylindrical tube.

4. The window of claim 1 wherein the desiccant concealing member is elongated and has a substantially U-shaped cross-sectional profile.

5. The window of claim 6 wherein the cross-sectional profile comprises two linear segments joining at a substantially right angle.

6. The window of claim 1 wherein the frame comprises an outer channel member, an inner channel member, a web member disposed between the outer and inner channel members, wherein the desiccant concealing member is detachably connected to the inner channel member.

7. The window of claim 6 wherein the desiccant concealing member is comprised of a resilient material and comprises a first lip and a second lip which each engage an undercut groove in the inner channel member.
